(19) United States
(12) Patent Application Publication
(10) Pub. No.: US 2017/0098404 A1
(43) Pub. Date: Apr. 6, 2017

(54) DISPLAY DRIVING CIRCUIT

(71) Applicant: SILICON WORKS CO., LTD., Daejeon (KR)

(72) Inventors: Hae Won LEE, Cheongju-si (KR); Hyun Ho CHO, Incheon-si (KR); Jung Bae YUN, Daejeon-si (KR); Ju Young SHIN, Daejeon (KR)

(73) Assignee: SILICON WORKS CO., LTD., Daejeon (KR)

(21) Appl. No.: 15/276,907

(22) Filed: Sep. 27, 2016

(30) Foreign Application Priority Data
Oct. 1, 2015 (KR) 10-2015-0138559

(51) Int. Cl. G09G 3/20

(52) U.S. Cl. CPC G09G 3/2011; G09G 3/2096; G09G 2310/027; G09G 2310/0291; G09G 2320/0673; G09G 2320/0223

(57) ABSTRACT

Provided is a display driving circuit capable of achieving high speed and high resolution by improving an output slew rate. The display driving circuit may include: a gradation voltage generation unit including a plurality of resistor strings corresponding to a plurality of groups into which channels corresponding to display data are grouped, the plurality of resistor strings being configured to provide gradation voltages to digital-analog converters (DACs) corresponding to the respective channels of the corresponding groups; and a display driving unit including the DACs and buffers corresponding to the respective channels, wherein the DACs convert the corresponding display data into data voltages using the gradation voltages, and the buffers provide the corresponding data voltages as source driving signals to a display panel.

### BACKGROUND

1. Technical Field

The present disclosure relates to a display device, and more particularly, to a display driving circuit capable of achieving high speed and high resolution.

2. Related Art

In general, a display device includes a display panel, a gate driver, a source driver and a timing controller.

The display panel includes a gate line and a data line, the gate driver supplies a gate driving signal to the gate line, and the source driver supplies a source driving signal to the data line. The timing controller provides display data to the source driver. The display data include pixel data.

The source driver forms a large number of channels for providing source driving signals corresponding to the display data to the display panel, and digital-to-analog converters (DACs) and buffers are installed at the respective channels.

The source driver according to the related art includes one resistor string which generates gradation voltages using a gamma reference voltage, and the resistor string commonly provides the gradation voltages to the DACs of the respective channels.

The DACs of the respective channels convert pixel data into data voltages using the gradation voltages, and the buffers of the respective channels provide the data voltages as the source driving signals to the display panel.

In the source driver according to the related art, however, one resistor string covers a large number of channels. Thus, the parasitic capacitors of the respective channels and the parasitic capacitors of the input transistors of the buffers cause RC delay, thereby having an influence on the output of the source driving signals.

Therefore, the related art is difficult to apply to a high-speed and high-resolution display device.

### SUMMARY

Various embodiments are directed to a display driving circuit capable of reducing a parasitic capacitor which serves as a load of a resistor string.

Also, various embodiments are directed to a display driving circuit capable of improving an output slew rate by reducing RC delay caused by a parasitic capacitor.

Also, various embodiments are directed to a display driving circuit which can be applied to a high-speed and high-resolution display device due to an improvement of an output slew rate.

In an embodiment, a display driving circuit may include: a gradation voltage generation unit including a plurality of resistor strings corresponding to a plurality of groups into which channels corresponding to display data are grouped, the plurality of resistor strings being configured to provide gradation voltages to digital-analog converters (DACs) corresponding to the respective channels of the corresponding groups; and a display driving unit including the DACs and buffers corresponding to the respective channels, wherein the

DACs convert the corresponding display data into data voltages using the gradation voltages, and the buffers provide the corresponding data voltages as source driving signals to a display panel.

In another embodiment, a display driving circuit may include: a first resistor string configured to provide gradation voltages to DACs of odd-numbered channels among a plurality of channels corresponding to display data; a second resistor string configured to provide the gradation voltages to DACs of even-numbered channels among the plurality of channels; a DAC unit including the DACs corresponding to the respective channels, the DACs being configured to convert the corresponding display data into data voltages using the gradation voltages; and an output buffer unit including buffers corresponding to the respective DACs, the buffers being configured to provide the corresponding data voltages as source driving signals to a display panel.

In another embodiment, a display driving circuit may include: a first resistor string configured to provide gradation voltages to DACs of left channels based on the center of two parts into which channels corresponding to display data are divided into an equal number; a second resistor string configured to provide the gradation voltages to DACs of right channels based on the center; a DAC unit including the DACs corresponding to the respective channels, the DACs being configured to convert the corresponding display data into data voltages using the gradation voltages; and an output buffer unit including buffers corresponding to the respective DACs, the buffers being configured to provide the corresponding data voltages as source driving signals to a display panel.

### BRIEF DESCRIPTION OF THE DRAWINGS

FIG. 1 is a block diagram illustrating a display driving circuit according to an embodiment of the present invention.

FIG. 2 is a circuit diagram for describing the display driving circuit of FIG. 1.

FIG. 3 is a circuit diagram for describing another embodiment of the display driving circuit of FIG. 1.

### DETAILED DESCRIPTION

Hereafter, embodiments of the present invention will be described in detail with reference to the accompanying drawings. The terms used in the present specification and claims are not limited to typical dictionary definitions, but must be interpreted into meanings and concepts which coincide with the technical idea of the present invention.

Embodiments described in the present specification and configurations illustrated in the drawings are preferred embodiments of the present invention, and do not represent the entire technical idea of the present invention. Thus, various equivalents and modifications capable of replacing the embodiments and configurations may be provided at the point of time that the present application is filed.

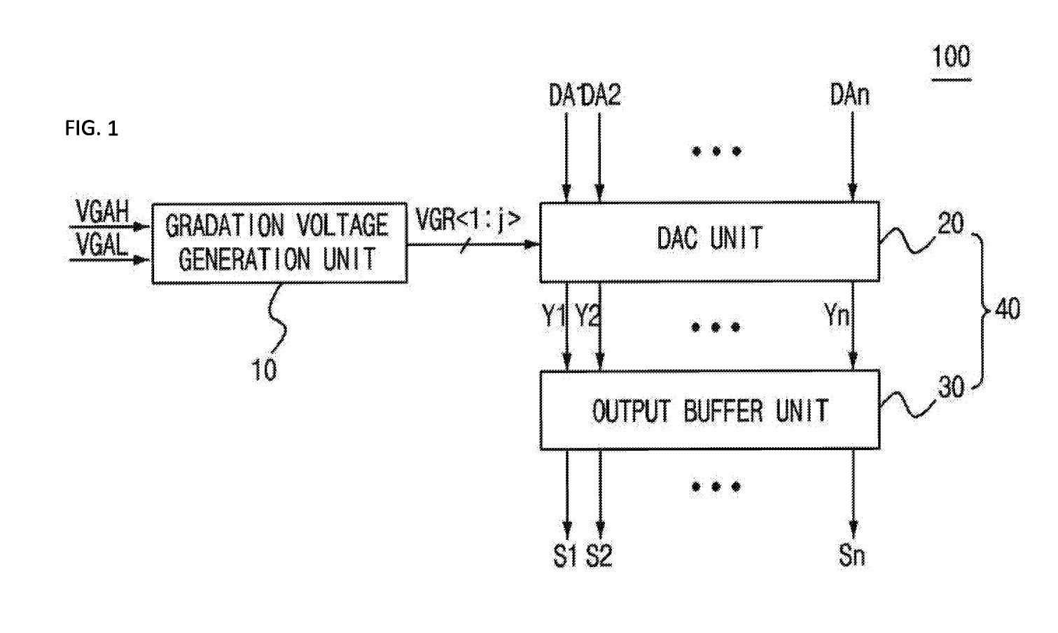

FIG. 1 is a block diagram illustrating a display driving circuit according to an embodiment of the present invention.

Referring to FIG. 1, the display driving circuit 100 according to the embodiment of the present invention includes a gradation voltage generation unit 10 and a display driving unit 40. The display driving circuit 100 may be configured as a source driver.

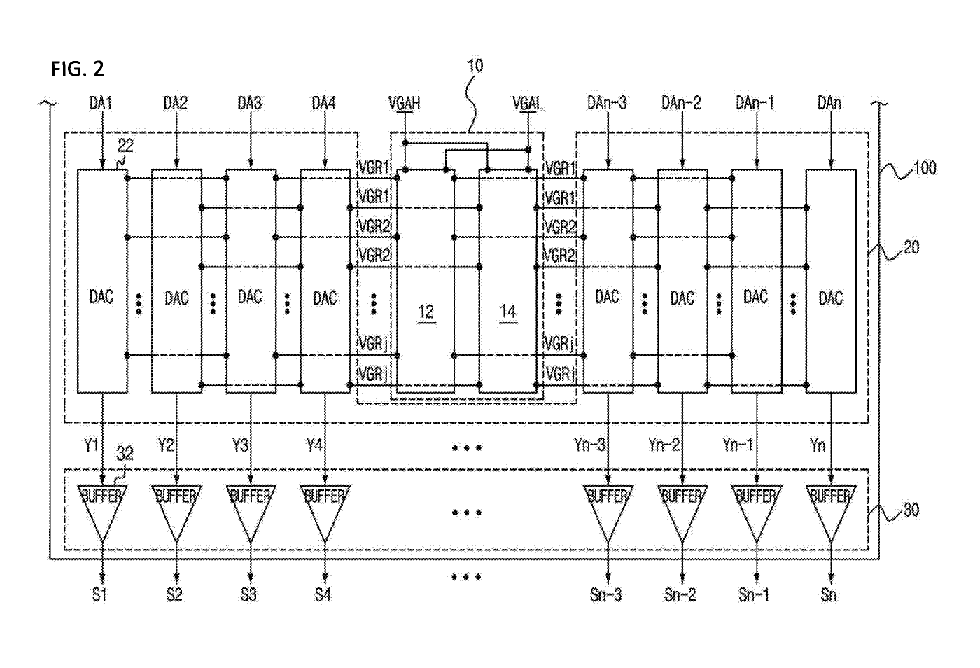

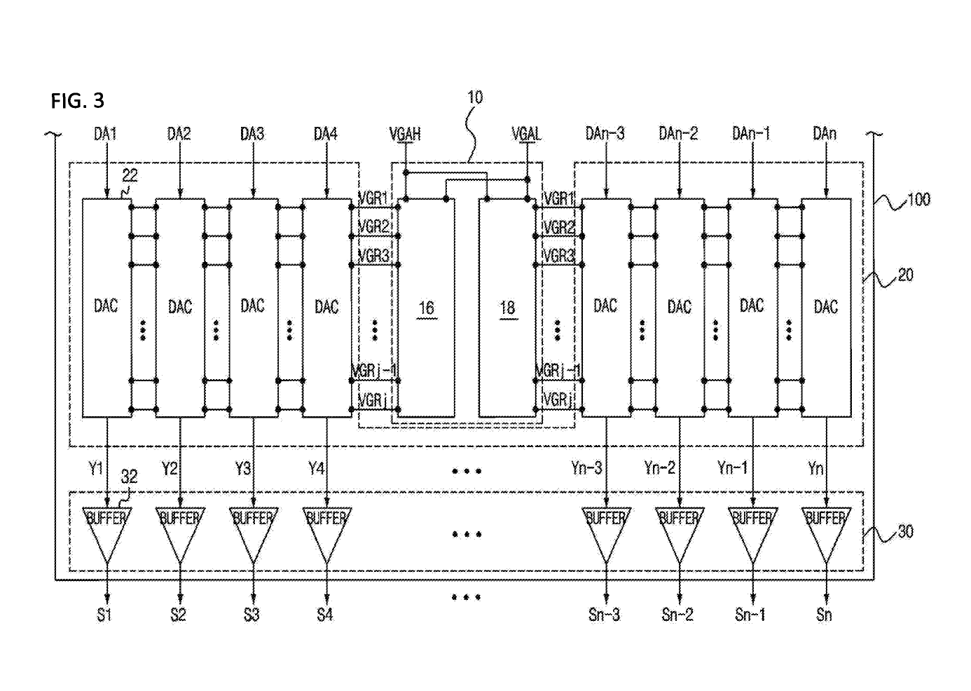

The gradation voltage generation unit 10 includes a plurality of resistor strings 12 and 14 (refer to FIGS. 2 and 3), receives gamma reference voltages VGAH and VGAL provided from outside, and generates gradation voltages VGR1 to VGRj using the gamma reference voltages VGAH and VGAL.

The gamma reference voltage VGAH indicates a high-level reference voltage for generating the gradation voltages VGR1 to VGRj, and the gamma reference voltage VGAL indicates a low-level reference voltage for generating the gradation voltages. The gamma reference voltages VGAH and VGAL may have the same polarity or different polarities, and the gamma reference voltage VGAH may have a higher electrical potential than the gamma reference voltage VGAL.

The plurality of resistor strings 12 and 14 of the gradation voltage generation unit 10 share the gamma reference voltages VGAH and VGAL, and generate the gradation voltages VGR1 to VGRj using divided voltages between the gamma reference voltage VGAH and the gamma reference voltage VGAL.

In the present embodiment, it has been described that the gradation voltage generation unit 10 generates the gradation voltages VGR1 to VGRj using the two gamma reference voltages VGAH and VGAL. However, depending on the type of a display panel, the gamma reference voltages VGAH and VGAL may be divided into a plurality of steps such as three or ten steps, and the gradation voltage generation unit 10 may generate the gradation voltages VGR1 to VGRj using the gamma reference voltages divided into a plurality of steps.

The gradation voltages VGR1 to VGRj are used when a digital-to-analog conversion (DAC) unit 20 converts display data DA1 to DAn into data voltages Y1 to Yn.

The display driving circuit 100 forms a plurality of channels for providing source driving signals S1 to Sn corresponding to the display data DA1 to DAn to the display panel.

The plurality of channels may be grouped into one or more groups, and one resistor string may be matched with one group. Each of the resistor strings independently provides the gradation voltages VGR1 to VGRj to DACs 22 of the respective channels of the corresponding groups.

For example, the channels may be grouped into odd-numbered channels and even-numbered channels, and each of the resistor strings matched with the odd-numbered channels and the even-numbered channels independently provides the gradation voltages VGR1 to VGRj to the DACs 22 of the corresponding channels.

The channels may be grouped into the left channels and the right channels based on the center of two parts into which the channels are divided into an equal number, and each of the resistor strings which are matched with the left channels and the right channels independently provides the gradation voltages VGR1 to VGRj to the DACs 22 of the respective channels of the corresponding groups.

Alternatively, the channels may be grouped into left odd-numbered channels, right even-numbered channels, left even-numbered channels and right odd-numbered channels, based on the center of two parts into which the channels are divided into the equal number, and each of resistor strings which are matched with the left odd-numbered channels, the right even-numbered channels, the left even-numbered channels and the right odd-numbered channels may independently provide the gradation voltages VGR1 to VGRj to the DACs 22 of the respective channels of the corresponding groups.

As such, the plurality of resistor strings 12 and 14 are matched to the respective groups, and independently provide the gradation voltages VGR1 to VGRj to the DACs 22 of the respective channels of the corresponding groups.

In another embodiment, the channels may be grouped in a different manner, and the resistor strings may be matched with the respective groups, and independently provide the gradation voltages VGR1 to VGRj to the DACs 22 of the respective channels of the corresponding groups.

The plurality of resistor strings 12 and 14 may be arranged between two parts into which the channels divided into the equal number, such that no deviation occurs in the gradation voltages VGR1 to VGRj provided to the DACs 22 of the channels.

For example, when the display driving circuit 100 forms eight channels, the plurality of resistor strings 12 and 14 may be arranged between four channels and four channels into which the eight channels are divided. Furthermore, the plurality of resistor strings 12 and 14 may be arranged in the center of the two parts into which the channels are divided.

The present invention is not limited thereto, but the plurality of resistor strings 12 and 14 may be arranged at positions where the distances from the resistor string 12 to the DACs 22 of the corresponding channels are equal to the distances from the resistor string 14 to the DACs 22 of the corresponding channels, respectively.

Each of the resistor strings 12 and 14 provides the gradation voltages VGR1 to VGRj to an equal number of DACs 22, and generates the gradation voltages VGR1 to VGRj having the same level using the shared gamma reference voltages VGAH and VGAL.

The display driving unit 40 converts the display data DA1 to DAn of the respective channels into the corresponding data voltages Y1 to Yn, using the gradation voltages VGR1 to VGRj provided from the gradation voltage generation unit 10, and provides the data voltages Y1 to Yn as the source driving signals S1 to Sn to the display panel.

The display driving unit 40 includes the DAC unit 20 and an output buffer unit 30.

The DAC unit 20 includes the DACs 22 corresponding to the respective channels, and the DACs 22 convert the corresponding display data DA1 to DAn into the data voltages Y1 to Yn, using the gradation voltages VGR1 to VGRj.

The output buffer unit 30 includes buffers 32 corresponding to the respective DACs 22, and the buffers 32 provide the corresponding data voltages Y1 to Yn as the source driving signals S1 to Sn to the display panel.

As described above, the plurality of resistor strings 12 and 14 independently provide the gradation voltages VGR1 to VGRj to the DACs 22 of the respective channels of the corresponding groups. Thus, a parasitic capacitor serving as a load of the gradation voltage generation unit 10 can be reduced to a half of the parasitic capacitor in the related art.

Therefore, the display driving circuit according to the present embodiment can improve an output slew rate by reducing RC delay caused by the parasitic capacitor. Therefore, the display driving circuit can be applied to a high-speed and high-resolution display device, due to the improvement of the output slew rate.

Although not illustrated in FIG. 1, the display driving circuit 100 may include a data restoration unit (not illustrated) for restoring the display data DA1 to DAn provided from a timing controller (not illustrated) and a latch unit (not illustrated) for latching the display data DA1 to DAn.

FIG. 2 is a circuit diagram for describing the display driving circuit of FIG. 1.

Referring to FIG. 2, the display driving circuit 100 according to the present embodiment includes the resistor string 12, the resistor string 14, the DAC unit 20 and the output buffer unit 30.

The resistor string 12 independently provides the gradation voltages VGR1 to VGRj to the DACs 22 of the odd-numbered channels among the channels corresponding to the display data DA1 to DAn, and the resistor string 14 independently provides the gradation voltages VGR to VGRj to the DACs 22 of the even-numbered channels among the channels corresponding to the display data DA1 to DAn.

The resistor strings 12 and 14 are arranged between two parts into which the channels are divided into an equal number, share the gamma reference voltages VGAH and VGAL provided form outside, and independently generate the gradation voltages VGR1 to VGRj using the shared gamma reference voltages VGAH and VGAL. The present invention is not limited thereto, but the resistor strings 12 and 14 may be arranged at positions where the distances from the resistor string 12 to the DACs 22 of the corresponding channels are equal to the distances from the resistor string 14 to the DACs 22 of the corresponding channels, respectively.

Each of the resistor strings 12 and 14 includes a plurality of resistors (not illustrated) which are sequentially coupled in series between the gamma reference voltages VGAH and VGAL, and generates the gradation voltages VGR1 to VGRj using node voltages between the respective resistors.

The DAC unit 20 includes the DACs 22 corresponding to the respective channels, and the DACs 22 include switches (not illustrated) for selecting the gradation voltages VGR1 to VGRj in response to the corresponding display data DA1 to DAn.

The DACs 22 corresponding to the respective channels convert the display data DA1 to DAn into the data voltages Y1 to Yn, using the gradation voltages VGR1 to VGRj provided from the resistor string 12 or 14.

The output buffer unit 30 includes buffers 32 corresponding to the DACs 22, and the buffers 32 provide the corresponding data voltages Y1 to Yn as the source driving signals S1 to Sn to the display panel.

As described above, the resistor strings 12 and 14 independently provide the gradation voltages VGR1 to VGRj to the DACs 22 of the even-numbered channels and the odd-numbered channels, respectively. Thus, a parasitic capacitor serving as a load of the resistor strings 12 and 14 can be reduced to a half of the parasitic capacitor in the related art.

Therefore, the display driving circuit according to the present embodiment can improve an output slew rate by reducing RC delay caused by the parasitic capacitor. Due to the improvement of the output slew rate, the display driving circuit can be applied to a high-speed and high-resolution display device.

FIG. 3 is a circuit diagram for describing another embodiment of the display driving circuit of FIG. 1.

Referring to FIG. 3, the display driving circuit according to the present embodiment includes a resistor string 16, a resistor string 18, a DAC unit 20 and an output buffer unit 30.

The resistor string 16 independently the provides gradation voltages VGR1 to VGRj to the DACs 22 of the left channels which are arranged in the left side based on the center of two parts into which the channels corresponding to display data DA1 to DAn are divided, and the resistor string 18 independently provides the gradation voltages VGR1 to VGRj to the DACs 22 of the right channels which are arranged in the right side based on the center.

The resistor strings 16 and 18 are arranged between the two parts into which the channels are divided into an equal number, share gamma reference voltages VGAH and VGAL provided form outside, and independently generate the gradation voltages VGR1 to VGRj using the shared gamma reference voltages VGAH and VGAL. The present invention is not limited thereto, but the plurality of resistor strings 16 and 18 may be arranged at positions where the distances from the resistor string 12 to the DACs 22 of the corresponding channels are equal to the distances from the resistor string 14 to the DACs 22 of the corresponding channels, respectively.

Each of the resistor strings 16 and 18 includes a plurality of resistors (not illustrated) which are sequentially coupled in series between the gamma reference voltages VGAH and VGAL, and generates the gradation voltages VGR1 to VGRj using node voltages between the respective resistors.

The DAC unit 20 includes the DACs 22 corresponding to the respective channels, and the DACs 22 include switches (not illustrated) for selecting the gradation voltages VGR1 to VGRj in response to the corresponding display data DA1 to DAn.

The DACs 22 corresponding to the respective channels convert the display data DA1 to DAn into the data voltages Y1 to Yn, using the gradation voltages VGR1 to VGRj provided from the resistor string 16 or 18.

The output buffer unit 30 includes buffers 32 corresponding to the DACs 22, and the buffers 32 provide the corresponding data voltages Y1 to Yn as the source driving signals S1 to Sn to a display panel.

As described above, the resistor strings 16 and 18 independently provide the gradation voltages VGR1 to VGRj to the DACs 22 of the left channels and the right channels, respectively. Thus, a parasitic capacitor serving as a load of the resistor strings 16 and 18 can reduced to a half of the parasitic capacitor in the related art.

Therefore, the display driving circuit according to the present embodiment can improve an output slew rate by reducing RC delay caused by the parasitic capacitor. Due to the improvement of the output slew rate, the display driving circuit can be applied to a high-speed and high-resolution display device.

According to the embodiments of the present invention, the channels of the display driving circuit are grouped into a plurality of groups, and the gradation voltages are independently provided to the respective groups. Thus, the display driving circuit can reduce a parasitic capacitor serving as a load of the resistor strings.

Furthermore, the display driving circuit can improve the output slew rate by reducing RC delay caused by a parasitic capacitor, and can be applied to a high-speed and high-resolution display device due to the improvement of the output slew rate.

While various embodiments have been described above, it will be understood to those skilled in the art that the embodiments described are by way of example only. Accordingly, the disclosure described herein should not be limited based on the described embodiments.

What is claimed is:

1. A display driving circuit comprising:
a gradation voltage generation unit comprising a plurality of resistor strings corresponding to a plurality of groups into which channels corresponding to display data are grouped, the plurality of resistor strings being configured to provide gradation voltages to digital-analog converters (DACs) corresponding to the respective channels of the corresponding groups; and
a display driving unit comprising the DACs and buffers corresponding to the respective channels, wherein the DACs convert the corresponding display data into data voltages using the gradation voltages, and the buffers provide the corresponding data voltages as source driving signals to a display panel.

2. The display driving circuit of claim 1, wherein the plurality of resistor strings are arranged between two parts into which the channels are divided into an equal number.

3. The display driving circuit of claim 1, wherein the plurality of resistor strings are configured to share a plurality of gamma reference voltages provided from outside, and generate the gradation voltages using the plurality of gamma reference voltages.

4. The display driving circuit of claim 1, wherein the plurality of resistor strings are configured to provide the gradation voltages to the DACs of the channels which are grouped into odd-numbered channels and even-numbered channels.

5. The display driving circuit of claim 1, wherein the plurality of resistor strings are configured to provide the gradation voltages to the DACs of the channels which are grouped into left channels and right channels, based on the center of two parts into which the channels are divided into an equal number.

6. The display driving circuit of claim 1, wherein the plurality of resistor strings are configured to provide the gradation voltages to the DACs of the channels which are grouped into left odd-numbered channels, right even-numbered channels, left even-numbered channels and right odd-numbered channels, based on the center of two parts into which the channels are divided into an equal number.

7. The display driving circuit of claim 1, wherein each of the resistor strings is configured to provide the gradation voltages to an equal number of DACs.

8. The display driving circuit of claim 1, wherein each of the resistor strings is configured to generate the same gradation voltages.

9. A display driving circuit comprising:
a first resistor string configured to provide gradation voltages to DACs of odd-numbered channels among a plurality of channels corresponding to display data;
a second resistor string configured to provide the gradation voltages to DACs of even-numbered channels among the plurality of channels;
a DAC unit comprising the DACs corresponding to the respective channels, the DACs being configured to convert the corresponding display data into data voltages using the gradation voltages; and
an output buffer unit comprising buffers corresponding to the respective DACs, the buffers being configured to provide the corresponding data voltages as source driving signals to a display panel.

10. The display driving circuit of claim 9, wherein the first and second resistor strings are arranged between two parts into which the channels are divided into an equal number.

11. The display driving circuit of claim 9, wherein the first and second resistor strings share a gamma reference voltage provided from outside, and generate the gradation voltages using the gamma reference voltage.

12. A display driving circuit comprising:
a first resistor string configured to provide gradation voltages to DACs of left channels based on the center of two parts into which channels corresponding to display data are divided into an equal number;
a second resistor string configured to provide the gradation voltages to DACs of right channels based on the center;
a DAC unit comprising the DACs corresponding to the respective channels, the DACs being configured to convert the corresponding display data into data voltages using the gradation voltages; and
an output buffer unit comprising buffers corresponding to the respective DACs, the buffers being configured to provide the corresponding data voltages as source driving signals to a display panel.

13. The display driving circuit of claim 12, wherein the first and second resistor strings are arranged between two parts into which the channels are divided into an equal number.

14. The display driving circuit of claim 12, wherein the first and second resistor strings share a gamma reference voltage provided from outside, and the generate the gradation voltages using the gamma reference voltage.
